(19) United States
(12) Patent Application Publication
(10) Pub. No.: US 2017/0003844 A1
(43) Pub. Date: Jan. 5, 2017

(54) DYNAMIC LEAD GENERATION

(71) Applicant: LinkedIn Corporation, Mountain View, CA (US)

(72) Inventors: John P. Loof, San Francisco, CA (US); Dennis D. Li, Berkley, CA (US)

(73) Assignee: LINKEDIN CORPORATION, Mountain View, CA (US)

(21) Appl. No.: 14/791,345

(22) Filed: Jul. 3, 2015

(51) Int. Cl. G06F 3/0483; G06F 17/22

(52) U.S. Cl. CPC G06F 3/0483; G06F 17/2247

(57) ABSTRACT

In order to build or aggregate lists of potential customers, contact information may be collected from viewers of a document, such as a presentation. In particular, multiple pages in a document associated with a user of a social network (such as slides in a presentation) may be presented to a second user of the social network. At one or more dynamically selected pages or locations in the document and/or a dynamically selected position or location on a page, the second user may be requested to provide their contact information and/or additional information. Moreover, the contact information needed from the second user may be dynamically determined.

### BACKGROUND

### Field

The described embodiments relate to techniques for dynamically collecting information. More specifically, described embodiments relate to techniques for dynamically collecting information from views of documents (such as presentations).

### Related Art

Many organizations attempt to generate leads, including sales information about potential customers. In principle, this sales information can be used by an organization to identify, contact and then close sales. For example, an inside sales organization may collect or aggregate leads, and an outside sales organization can use the leads to generate sales.

However, in practice, promising leads often turn out to be incorrect, and the potential customers are, in fact, not interested in purchasing a good or a service. In addition to the lost revenue, such incorrect or inaccurate leads can represent a significant opportunity cost because, with more accurate leads, valuable sales resources could have been directed elsewhere. Thus, incorrect leads can be very frustrating to companies and can result in reduced marketshare and revenue.

### BRIEF DESCRIPTION OF THE FIGURES

FIG. 1 is a block diagram illustrating a system used to aggregate topic content in accordance with an embodiment of the present disclosure.

FIG. 2 is a flow chart illustrating a method for requesting contact information in accordance with an embodiment of the present disclosure.

FIG. 3 illustrates communication between the electronic devices of FIG. 1 in accordance with an embodiment of the present disclosure.

FIG. 4 is a drawing illustrating a document with multiple pages in accordance with an embodiment of the present disclosure.

FIG. 5 is a block diagram illustrating a computer system that performs the method of FIGS. 2 and 3 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In order to build or aggregate lists of potential customers (which are sometimes referred to as ‘leads’), contact information may be collected from viewers of a document, such as a presentation. In particular, multiple pages in a document associated with a user of a social network (such as slides in a presentation) may be presented to a second user of the social network. At one or more dynamically selected pages or locations in the document and/or a dynamically selected position or location on a page, the second user may be requested to provide their contact information and/or additional information. Moreover, the contact information needed from the second user may be dynamically determined.

For example, the dynamic selection may be based on the viewing behavior of other users of the social network for the document, such as an average number of pages viewed by the other users and/or a number of views of the document by the other users. Alternatively or additionally, the dynamic selection may be based on: the type of the document, a type of content in the document, and/or a number of pages in the document. Thus, the location may be different for different types of documents, types of content and/or different document sizes. In some embodiments, the dynamic selection is based on the effectiveness (in terms of user response rates, the accuracy of the information received, etc.) of historical selected positions of information requests in documents.

In this way, this lead-generation technique may allow contact information to be dynamically, efficiently and effectively collected from viewers of documents in the social network. Moreover, by adapting when and where the contact information is requested, the lead-generation technique may increase the likelihood of receiving accurate responses to these requests. Furthermore, the lead-generation technique may allow the contact information to be collected from a targeted subset of the viewers of the document, perhaps based on predefined criteria (e.g., particular attributes in user profiles of the viewers). Consequently, the lead-generation technique may allow more accurate lists of potential customers to be built, which may reduce companies' frustration and the opportunity costs associated with incorrect leads. This may allow companies to leverage the lists of potential customers to increase revenue and marketshare.

In the discussion that follows, an individual or a user may be a person (for example, an existing user of the social network or a new user of the social network). Also, or instead, the lead-generation technique may be used by any type of organization, such as a business. Furthermore, a ‘business’ should be understood to include for-profit corporations, non-profit corporations, groups (or cohorts) of individuals, sole proprietorships, government agencies, partnerships, etc.

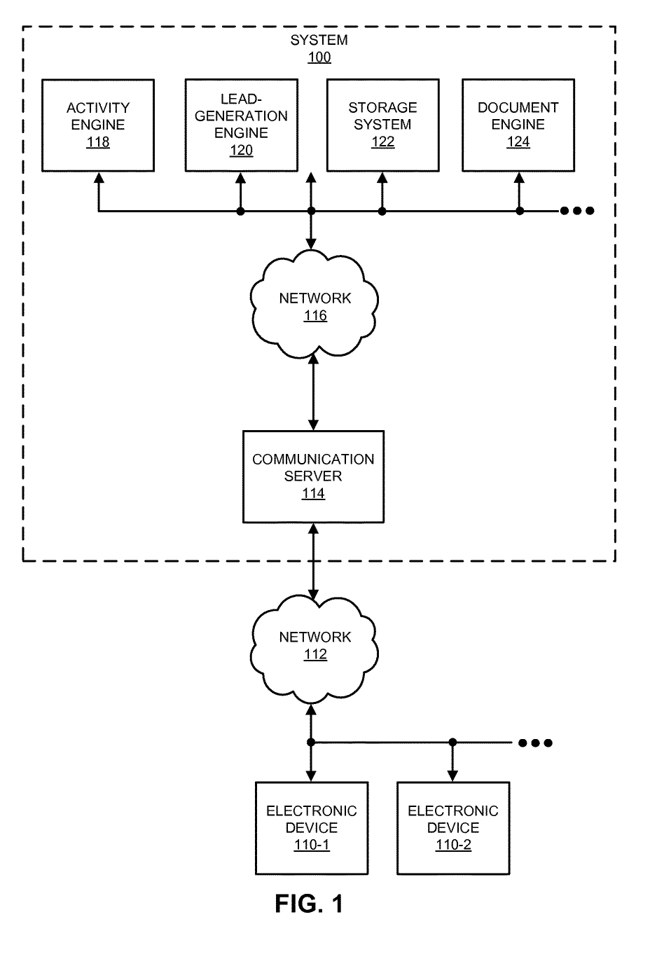

We now describe embodiments of the system and its use. FIG. 1 presents a block diagram illustrating a system 100 that performs the lead-generation technique. In this system, users of electronic devices 110 may use a software product, such as instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

Using one of electronic devices 110 (such as electronic device 110-1) as an illustrative example, a user of electronic device 110-1 may use the software application to interact with other users in a social network (and, more generally, a network of users), such as a professional social network, which facilitates interactions among the users. Note that each of the users of the software application may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections.

In particular, when using the software application, the users may view documents that were posted by other users of the social network. The documents may include presentations with multiple slides. However, the documents may include a wide variety of content, including: word-processor documents or files with multiple pages, spreadsheets with multiple tabs, websites with multiple web pages, albums with multiple pictures, etc. In general, the documents may include: audio, video, text, graphics, multimedia content, verbal, written, and/or recorded information. Note that documents may be presented to the users by document engine 124 via the software application that executes in the environment of electronic devices 110.

Over time, via network 116, an activity engine 118 in system 100 may aggregate viewing behavior of the users when they view the documents. This aggregated information may be stored in a data structure, which is stored in a computer-readable memory, such as storage system 122 that may encompass multiple devices, i.e., a large-scale storage system. For example, the viewing behavior for a particular document may include an average number of pages in the document that are viewed by the users and/or a number of views of the document by the users.

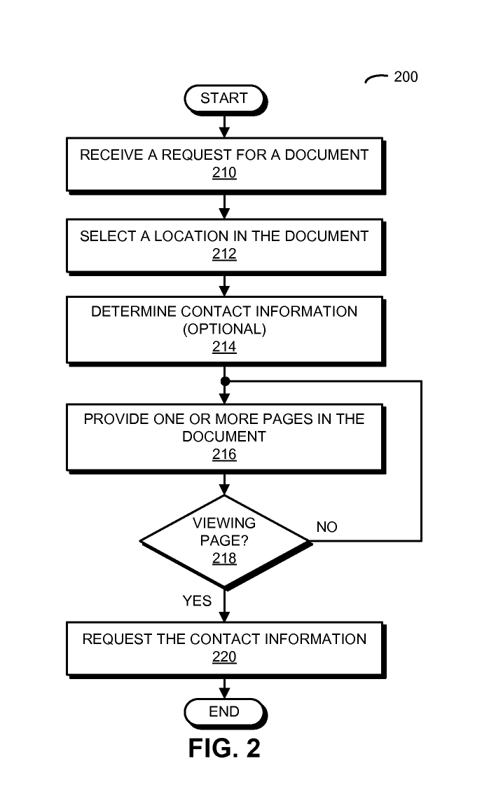

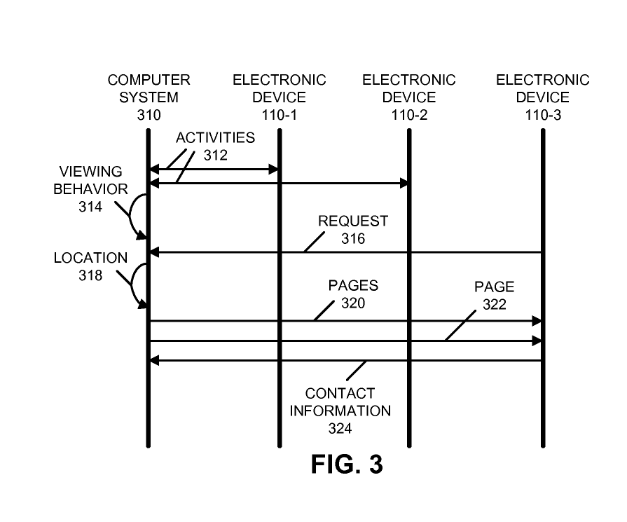

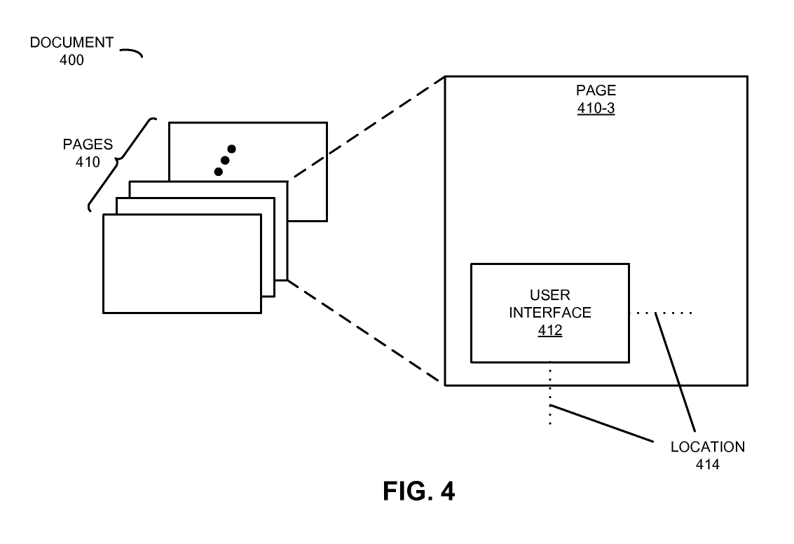

As described further below with reference to FIGS. 2 and 3, when a user of one of electronic devices 110 (such as electronic device 110-1) provides a request for the document via the software application that executes in the environment of electronic device 110-1 and communication server 114, lead-generation engine 120 may select a location in the document to request contact information from the user. Moreover, as described further below with reference to FIG. 4, the location may include a page in the document and/or a position on the page in the document where a request for contact information is presented.

Then, document engine 124 may provide multiple pages in the document to electronic device 110-1 via communication server 114 as the user views the document. When the user views the page, lead-generation engine 120 may request the contact information from the user via communication server 114. For example, the contact information may be requested by displaying or presenting a contact-information form or user interface at the location on the page.

The user may populate the requested contact information in the contact-information form, which is then submitted to lead-generation engine 120 via the software application that executes in the environment of electronic device 110-1 and communication server 114. Lead-generation engine 120 may store the contact information in another data structure, which is stored in a computer-readable memory, such as storage system 122.

Note that the location of the contact-information form may be based on a variety of factors. For example, as noted previously, the location may be dynamically selected based on the aggregated viewing behavior of other users of the social network. In particular, if the other users, on average, only view the first three pages of the document, then it would be preferable to place the contact-information form on one of those pages, such as the second or third page (which will allow the user to first conclude that the document, and thus the provider of the document, is of interest). Similarly, the contact-information form may be placed later in the document (such as on slide nine out of ten slides) for popular documents that are viewed by a large number of users (such as more than 100 users). Thus, by using information about how the other users are interacting with the content in the document, lead-generation engine 120 may be able to optimize the placement of the contact-information form, so that accurate contact information is more likely to be received from the user.

Moreover, the location may be based on: a type of the document, a type of content in the document, and/or a number of pages in the document. For example, the contact-information form may be earlier in a research paper or a science article (such as on slide three) as opposed to a popular (such as a top-10) document or employment information (such as job openings), in which case the contact-information form may be presented later (such as near the end of the document). Similarly, the contact-information form may be presented earlier (such as on the third slide) in longer documents (e.g., documents that include more than ten pages).

Furthermore, the location may be based on attributes in a user profile of the user. For example, the provider (e.g., another user) of the document may have specified a predefined user profile with attributes that are associated with a targeted potential customer, such as a financial or business executive, a user with particular skills (e.g., a software programmer), etc.

Additionally, the location may be based on a time of day and/or a day of the week. For example, users may be busier (and, thus, may have shorter attention spans) on Mondays or in the morning. Therefore, on these days or times, the contact-information form may be presented to the user earlier in the document (such as on slide three).

In some embodiments, prior to requesting the contact information, lead-generation engine 120 dynamically determines the contact information needed from the user. For example, the contact information needed from the user may be determined based on attributes in the user profile of the user and/or information about the user that has already been collected. Thus, the specific contact information requested may vary from user to user.

While the preceding discussion illustrated the collection of contact information on behalf of the user that provided or published the document in the social network (who is sometimes referred to as the ‘publishing user’), in other embodiments lead-generation engine 120 requests contact information from the user on behalf of another user of the social network (such as a third party that is other than or different than the user or the publishing user), and/or individuals and/or organizations that are external to the social network. Thus, the contact-information form may be presented in someone else's presentation to collect contact information for another user.

In these ways, the lead-generation technique may allow users to use content posted or provided to the other users via the social network to collect or build accurate lists of potential customers based on the dynamic behaviors and the attributes of these viewers. These capabilities may increase the relevance or usefulness of the lists of potential customers, which may allow the users (as well as organizations, companies, governments, etc.) to obtain more effective sales opportunities. Consequently, the lead-generation technique may allow the users to increase their revenue and marketshare, and thus the lead-generation technique may result in increased engagement with or use of the social network, and thus may also increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

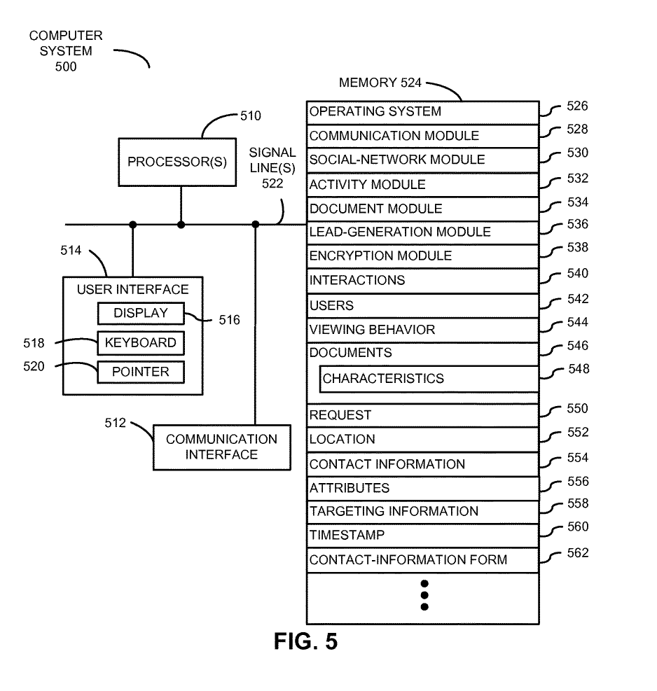

We now describe embodiments of the lead-generation technique. FIG. 2 presents a flow chart illustrating a method 200 for requesting contact information, which may be performed by a computer system (such as system 100 in FIG. 1 or computer system 500 in FIG. 5). During operation, the computer system receives, from an electronic device associated with a user of a social network, a request for a multi-page document (operation 210) that is associated with a second user of the social network. Then, the computer system selects a location in the document (operation 212) to request the contact information from the user, where the location includes a page in the multiple pages.

For example, as described further below with reference to FIG. 4, the location may include a position on the page in the document (such as on the lower left-hand side near the bottom of the page) where the request for the contact information is presented. As noted previously, the location may be selected based on one or more factors or variables, such as: viewing behavior of other users in the social network for the document, a type of the document, a type of content in the document, a number of pages in the document, the day of the week, the time of day, attributes in a user profile of the user, and/or one or more predefined user profile attributes specified by the second user.

Moreover, the computer system provides one or more pages in the document (operation 216) to the electronic device as the user views the document. When the user views the page (operation 218), the computer system requests the contact information (operation 220).

In some embodiments, the computer system optionally determines the contact information (operation 214) needed from the user prior to requesting the contact information (operation 220). For example, the contact information needed from the user may be determined based on attributes in a user profile of the user and/or information about the user that has already been collected. Thus, the requested contact information may complement the information about the user that has already been collected or determined.

In an exemplary embodiment, method 200 is implemented using one or more electronic devices and at least one server (and, more generally, a computer system), which communicate through a network, such as a cellular-telephone network and/or the Internet (e.g., using a client-server architecture). This is illustrated in FIG. 3. During this method, computer system 310 (which may implement some or all of the functionality of system 100 in FIG. 1) may monitor activities 312 (or interactions) of the users of electronic devices 110-1 and 110-2 in the social network to determine viewing behavior 314 of a document.

Then, computer system 310 may receive a request 316 from a user of electronic device 110-3 for the document. In response, computer system 310 may select a location 318 in the document (such as page 322 in the document) to request contact information from the user. For example, the location may be selected based on one or more factors or variables, such as viewing behavior 314.

As the user views the document, computer system 310 may provide multiple pages 320 in the document to electronic device 110-3. When the user views page 322, computer system 310 may request the user's contact information. In response, the user may provide contact information 324.

In some embodiments of method 200 (FIGS. 2 and 3), there may be additional or fewer operations. Moreover, the order of the operations may be changed, and/or two or more operations may be combined into a single operation.

In an exemplary embodiment, the lead-generation technique is used to aggregate a list of potential customers from at least some of the viewers of a document posted to a social network. For example, a boutique law firm may post a presentation about immigration law to the social network. This presentation may be used as a hook to attract the interest of potential customers.

Subsequently, the presentation may be viewed by multiple users of the social network. The behaviors of these users when viewing the presentation may be tracked. For example, the number of times the presentation is used and the average number of slides viewed may be monitored and stored.

Then, when a user requests to view the presentation, the stored viewing behavior, information about the presentation (such as the number of slides, the fact that the presentation is about immigration law, etc.), attributes of the user, target attributes of prospective customers that were specified by the boutique law firm when the presentation was posted, the day, the time, etc. may be used to dynamically select a location in the presentation where contact information can be collected from the user. The selected location may include one of the slides in the presentation and/or a preferred position on the selected slide.

By varying the selected location, the lead-generation technique may optimize the placement of a contact-information form (and, thus, collection of the contact information) based on a performance metric (such as how often users provide the contact information) and, more generally, how users are interacting with content in the presentation. Note that the use of historical viewing behavior data may allow experiments to be dynamically performed to optimize the placement of the contact-information form.

When the user views the slide, a contact-information form (or a slide or a link that the user may activate to see the contact-information form) may be presented to the user so that the user can provide their contact information. The information provided by the user may be stored in the list of potential customers of the boutique law firm. In some embodiments, the contact-information form is fully or partially prepopulated, so the user only has to change incorrect information (if any) and then click or activate an icon to accept or submit the contact information.

We now describe embodiments of a user interface (which is sometimes referred to as a ‘contact-information form’) that requests contact information from a user. FIG. 4 presents a drawing illustrating a document 400 with multiple pages 410. When a user views a selected page 410-3 in document 400, user interface 412 is presented at a location 414 on page 410-3. In response, the user can provide requested contact information by populating fields in user interface 412.

We now describe embodiments of a computer system for performing the lead-generation technique and its use. FIG. 5 presents a block diagram illustrating a computer system 500 that performs method 200 (FIGS. 2 and 3), such as system 100 in FIG. 1 or computer system 310 in FIG. 3. Computer system 500 includes one or more processing units or processors 510 (which are sometimes referred to as ‘processing modules’), a communication interface 512, a user interface 514, memory 524, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516 (such as a touchscreen), a keyboard 518, and/or a pointer 520 (such as a mouse).

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules, including: social-network module 530, activity module 532, document module 534, lead-generation module 536, and/or encryption module 538. Note that one or more of these program modules (or sets of instructions) may constitute a computer-program mechanism, i.e., software.

During operation of computer system 500, social-network module 530 facilitates interactions 540 among users 542 via communication module 528 and communication interface 512. These interactions may be tracked by activity module 532, and may include viewing behavior 544 of users 542 when viewing documents 546, provided by document module 534, in a social network that is implemented using social-network module 530.

When document module 534 receives, via communication interface 512 and communication module 528, a request 550 from a user to view a particular document in documents 546, lead-generation module 536 may select a location 552 where a request for contact information 554 is to be presented to the user. Note that location 552 may be based on one or more variables or factors, such as: viewing behavior 544, characteristics 548 of the particular document (such as a type of document, a type of content, a length of the particular document, etc.), attributes 556 of the user, targeting information 558 (such as predefined attributes of a targeted user), and/or a timestamp 560 (such as the day and/or the time).

Then, when the user reaches location 552, lead-generation module 536 may instruct document module 534 to present contact-information form 562 to the user via communication module 528 and communication interface 512. In response, the user may provide contact information 554 via communication interface 512 and communication module 528. For example, contact information 554 may include the user's name, address, telephone number, email address, title, and/or company.

Because information in computer system 500 may be sensitive in nature, in some embodiments at least some of the data stored in memory 524 and/or at least some of the data communicated using communication module 528 is encrypted using encryption module 538.

Instructions in the various modules in memory 524 may be implemented in a high-level procedural language, an object-oriented programming language, and/or in an assembly or machine language. Note that the programming language may be compiled or interpreted, e.g., configurable or configured, to be executed by the one or more processors.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 is implemented in one or more application-specific integrated circuits (ASICs) and/or one or more digital signal processors (DSPs).

Computer systems (such as computer system 500), as well as electronic devices, computers and servers in system 100 (FIG. 1), may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 112 (FIG. 1) may include: the Internet, World Wide Web (WWW), an intranet, a cellular-telephone network, LAN, WAN, MAN, or a combination of networks, or other technology enabling communication between computing systems.

System 100 (FIG. 1) and/or computer system 500 may include fewer components or additional components. Moreover, two or more components may be combined into a single component, and/or a position of one or more components may be changed. In some embodiments, the functionality of system 100 (FIG. 1) and/or computer system 500 may be implemented more in hardware and less in software, or less in hardware and more in software, as is known in the art.

While a social network has been used as an illustration in the preceding embodiments, more generally the lead-generation technique may be used to aggregate lists of potential customers in a wide variety of applications or systems. Moreover, the lead-generation technique may be used in applications where the communication or interactions among different entities (such as people, organizations, etc.) can be described by a social graph. Note that the people may be loosely affiliated with a website (such as viewers or users of the website), and thus may include people who are not formally associated (as opposed to the users of a social network who have user accounts). Thus, the connections in the social graph may be defined less stringently than by explicit acceptance of requests by individuals to associate or establish connections with each other, such as people who have previously communicated with each other (or not) using a communication protocol, or people who have previously viewed each other's home pages (or not), etc. In this way, the lead-generation technique may be used to expand the quality of interactions and value-added services among relevant or potentially interested people in a more loosely defined group of people.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-system-implemented method for requesting contact information, the method comprising:
receiving, from an electronic device associated with a user of a social network, a request for a document associated with a second user of the social network, wherein the document includes multiple pages;
selecting a location in the document to request the contact information from the user, wherein the location includes a page in the multiple pages;
providing the multiple pages in the document to the electronic device as the user views the document; and
when the user views the page, requesting the contact information.

2. The method of claim 1, wherein the location includes a position on the page in the document where the request for the contact information is presented.

3. The method of claim 1, wherein the location is based on viewing behavior of other users in the social network for the document.

4. The method of claim 3, wherein the viewing behavior includes an average number of pages viewed by the other users.

5. The method of claim 3, wherein the viewing behavior includes a number of views of the document by the other users.

6. The method of claim 1, wherein the location is based on one of: a type of the document, a type of content in the document, and a number of pages in the document.

7. The method of claim 1, wherein the location is based on attributes in a user profile of the user.

8. The method of claim 1, wherein the location is based on one of: a time of day, and a day of the week.

9. The method of claim 1, wherein the location is based on a predefined user profile specified by the second user.

10. The method of claim 1, wherein the document includes a presentation and the pages include slides.

11. The method of claim 1, wherein, prior to requesting the contact information, the method comprises dynamically determining the contact information needed from the user.

12. The method of claim 11, wherein the contact information needed from the user is determined based on one of: attributes in a user profile of the user, and information about the user that has already been collected.

13. The method of claim 1, wherein the contact information is requested on behalf of one of: the second user, and another user of the social network.

14. An apparatus, comprising:
one or more processors;
memory; and
a program module, wherein the program module is stored in the memory and, during operation of the apparatus, is executed by the one or more processors to request contact information, the program module including:
instructions for receiving, from an electronic device associated with a user of a social network, a request for a document associated with a second user of the social network, wherein the document includes multiple pages;
instructions for selecting a location in the document to request the contact information from the user, wherein the location includes a page in the multiple pages;
instructions for providing the multiple pages in the document to the electronic device as the user views the document; and
instructions for requesting the contact information when the user views the page.

15. The apparatus of claim 14, wherein the location includes a position on the page in the document where the request for the contact information is presented.

16. The apparatus of claim 14, wherein the location is based on viewing behavior of other users in the social network for the document.

17. The apparatus of claim 16, wherein the viewing behavior includes one of: an average number of pages viewed by the other users, and a number of views of the document by the other users.

18. The apparatus of claim 14, wherein the location is based on one of: a type of the document, a type of content in the document, and a number of pages in the document.

19. The apparatus of claim 14, wherein the location is based on one of:
attributes in a user profile of the user;
a time of day;
a day of the week; and
a predefined user profile specified by the second user.

20. A system, comprising:
a processing module comprising a non-transitory computer-readable medium storing instructions that, when executed, cause the system to:
receive, from an electronic device associated with a user of a social network, a request for a document associated with a second user of the social network, wherein the document includes multiple pages;
select a location in the document to request contact information from the user, wherein the location includes a page in the multiple pages;
provide the multiple pages in the document to the electronic device as the user views the document; and
when the user views the page, request the contact information.
